(19) United States
(12) Patent Application Publication
(10) Pub. No.: US 2025/0323493 A1
(43) Pub. Date: Oct. 16, 2025

(54) SELF-PROTECTING CIRCUIT BREAKER

(71) Applicant: Gemstone Lights Canada Ltd., Calgary (CA)

(72) Inventor: Hossein Bagherzadeh, Calgary (CA)

(21) Appl. No.: 19/250,914

(22) Filed: Jun. 26, 2025

Related U.S. Application Data
(63) Continuation-in-part of application No. 18/825,783, filed on Sep. 5, 2024.
Application No. 18/825,783 is a continuation of application No. 17/845,064, filed on Jun. 21, 2022, now Pat. No. 12,113,351.

(51) Int. Cl. H02H 3/20; H02H 1/00

(52) U.S. Cl. CPC H02H 3/20; H02H 1/0007

(57) ABSTRACT

A protection circuit is configured for inline installation between a DC power source and a load. The circuit includes a current sensing circuit, a control circuit having a non-adjustable reference voltage element to define a fixed overcurrent threshold power limit of about 60 volt-amperes, a comparison to generate an overcurrent trigger signal, and a latching circuit to actuate an relay based on the overcurrent trigger signal. The circuit further includes a logic combinator circuit to receive the overcurrent trigger and short-circuit signals, and inhibit closure of the relay if either is asserted. A short-circuit detection circuit detects persistent short circuits downstream of the relay, and the relay is configured to disconnect the load from the DC power source when actuated. The circuit further includes a low wattage output circuit downstream of the electric relay the includes a fail-safe protection device to permanently or temporarily open under sustained fault conditions.

### CROSS-REFERENCE TO RELATED APPLICATION DATA

This application is a continuation-in-part of U.S. patent application Ser. No. 18/825,783, titled SELF-PROTECTING CIRCUIT BREAKER, filed Sep. 5, 2024, which is a continuation of U.S. patent application Ser. No. 17/845,064, titled CIRCUIT BREAKER HAVING A CURRENT SENSING CIRCUIT, CONTROL CIRCUIT, ELECTRICAL RELAY AND LATCHING CIRCUIT, filed Jun. 21, 2022, now U.S. Pat. No. 12,113,351.

### BACKGROUND

This disclosure is related to a self-protecting circuit.

Power circuits may experience overcurrent shots resulting from a short circuit or other electric faults. A short circuit occurs when a current travels along an unintended path with no or very low electrical impedance. This results in an excessive current flowing through the circuit. An overcurrent or excess current occurs when a larger than intended electric current exists through a conductor, leading to excessive generation of heat, and the risk of fire or damage to the electrical equipment.

Fuses, circuit breakers, and current limiters are commonly used overcurrent protection (OCP) mechanisms to control the risks. A fuse operates to provide overcurrent protection of an electrical circuit. Its essential component is a metal wire or strip that melts when too much current flows through it, thereby stopping or interrupting the current. Circuit breakers operate by interrupting current flow to protect equipment and to prevent the risk of fire. Unlike a fuse, which operates once and then must be replaced, a circuit breaker can be reset (either manually or automatically) to resume normal operation.

Currently, different automatic circuit breakers exist. For example, power circuit breakers may have electric motor operators so they can open and close under remote control. Other circuit breakers include reclosers (close automatically after a delay) and polyswitches (automatically reset based on temperature levels). Polyswitches include Polymer Positive Temperature Coefficient (PPTC) auto-recovery fuses that are used to protect against short circuits and over-current. However, the ambient temperature has a large impact on PPTC auto-recovery fuses as they operate based on temperature levels. Other fast protective fuses cut themselves off when overcurrent occurs, but they do not have an auto-recover feature and therefore, they must be replaced.

Accordingly, it is desirable to provide an improved protection circuit. Desirably, such a circuit meets the requirement for inherently limited class 2 systems.

### BRIEF SUMMARY

A protection circuit is provided according to various embodiments. In an aspect, the protection circuit is configured for inline installation between a DC power source and a load. The circuit includes a current sensing circuit configured to measure current flowing toward the load, a control circuit having a non-adjustable reference voltage element, the control circuit configured to define a fixed overcurrent threshold corresponding to a power limit of about 60 volt-amperes (VA), and a comparison circuit operably coupled to the current sensing circuit and the control circuit, the comparison circuit configured to generate an overcurrent trigger signal.

The protection circuit further includes a latching circuit configured to actuate an electric relay based on the overcurrent trigger signal, a logic combinator circuit configured to receive the overcurrent trigger signal and a short-circuit signal, and inhibit closure of the electric relay if either the overcurrent trigger signal or the short-circuit signal is asserted, and a short-circuit detection circuit located electrically between the electric relay and the load, the short-circuit detection circuit configured to detect persistent short circuits downstream of the electric relay, the electric relay configured to disconnect the load from the DC power source when actuated.

The latching circuit can be configured to retain the latching circuit's state upon activation of either the overcurrent trigger signal or the short-circuit signal, and requires manual or power-reset intervention to restore the protection circuit's connection.

The protection circuit further includes a low wattage output circuit downstream of the electric relay, the low wattage output circuit comprising a fail-safe protection device configured to permanently or temporarily open under sustained fault conditions.

In embodiments, the current sensing circuit includes a resistors R7 and R8. The control circuit can include a TL431 programmable reference regulator configured as a fixed reference voltage source to ensure a constant overcurrent threshold. The comparison circuit can include an operational amplifier, resistor R12 and capacitors C5 and C6, and the latching circuit can include an NPN transistor (Q1) and a PNP transistor (Q2), and resistors R13, R14 and, R15.

In embodiments, the logic combinator circuit includes a discrete transistor-based logic network to perform an OR operation between outputs of the short-circuit detection circuit and the comparison circuit. The logic combinator can maintain the electric relay in an open state upon detection of a persistent short circuit and inhibits automatic reclosure until the fault condition is removed.

The short-circuit detection circuit can be electrically coupled to the electric relay and the load and be configured to sense fault conditions at a load terminal only when the electric relay is in the closed state.

The short-circuit detection circuit can include an NPN transistor (Q3), and resistors R16, R17, R18 and R19. The fail-safe protection or secondary protection device can be, for example, a polymeric positive temperature coefficient (PPTC), a permanent one-time fuse with a calibrated trip behavior resettable fuse or the like.

In embodiments, the low wattage output circuit includes a resistor RL and is load limited to 60VA. The fixed overcurrent threshold of the control circuit is selected such that, at a DC voltage of 12V, the output current is dynamically limited to maintain a power delivery ceiling not exceeding 60 VA.

In another aspect, a fail-safe DC load protection architecture includes a first-stage overcurrent control block comprising a current sensor, a comparator, and a control reference, a latching relay circuit triggered upon exceeding a fixed current threshold, a short-circuit detection block positioned after the relay and configured to prevent relay reclosure upon detection of a load-side short, and a secondary protection device integrated into the output circuit to permanently or thermally disconnect in the event of an upstream failure.

In embodiments, the fail-safe DC load protection architecture is configured to limit a maximum power output to less than or equal to 60 VA under all loading conditions, including a transient startup condition and a sustained short-circuit condition.

The foregoing general description and the following detailed description are examples only and are not restrictive of the present disclosure.

### BRIEF DESCRIPTION OF THE DRAWINGS

The benefits and advantages of the present embodiments will become more readily apparent to those of ordinary skill in the relevant art after reviewing the following detailed description and accompanying drawings, wherein:

FIG. 1 shows an illustration of a protection circuit according to an embodiment;

FIG. 2 shows a schematic of the protection circuit according to an embodiment;

FIGS. 3A-3C are graphical illustrations of simulated time domain analyses in which, FIG. 3A shows the current increase behavior of the protection circuit in volts (y-axis) vs. time (x-axis) in the presence of increasing current; FIG. 3B shows the behavior of the short circuit protection circuit in volts (y-axis) vs. time (x-axis) the presence of increasing current; and FIG. 3C shows the behavior of the control circuit in volts (y-axis) vs. time (x-axis) the presence of increasing current; and

FIGS. 4A-4C are graphical illustrations of simulated parametric domain analyses in which, FIG. 4A shows the behavior of the protection circuit in volts (y-axis) vs. time (x-axis) in the presence of two inputs at the same time (normal and edge current); FIG. 4B shows the behavior of the load (low power output) in volts (y-axis) vs. time (x-axis) in the presence of two inputs at the same time (normal and edge current); and FIG. 4C shows the behavior of the electric relay in volts (y-axis) vs. time (x-axis) in the presence of two inputs at the same time (normal and edge current).

### DETAILED DESCRIPTION

While the present disclosure is susceptible of embodiment in various forms, there is shown in the drawings and will hereinafter be described presently preferred embodiments with the understanding that the present disclosure is to be considered an exemplification and is not intended to limit the disclosure to the specific embodiments illustrated. The words “a” or “an” are to be taken to include both the singular and the plural. Conversely, any reference to plural items shall, where appropriate, include the singular.

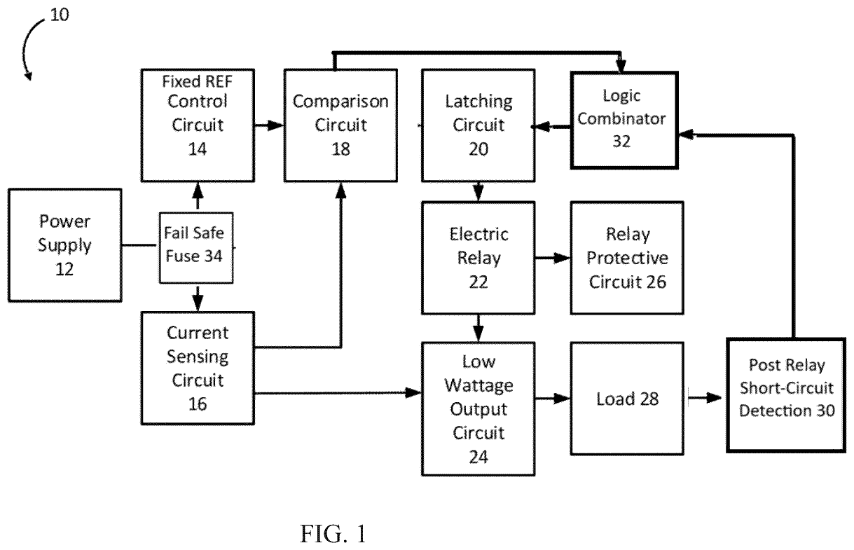

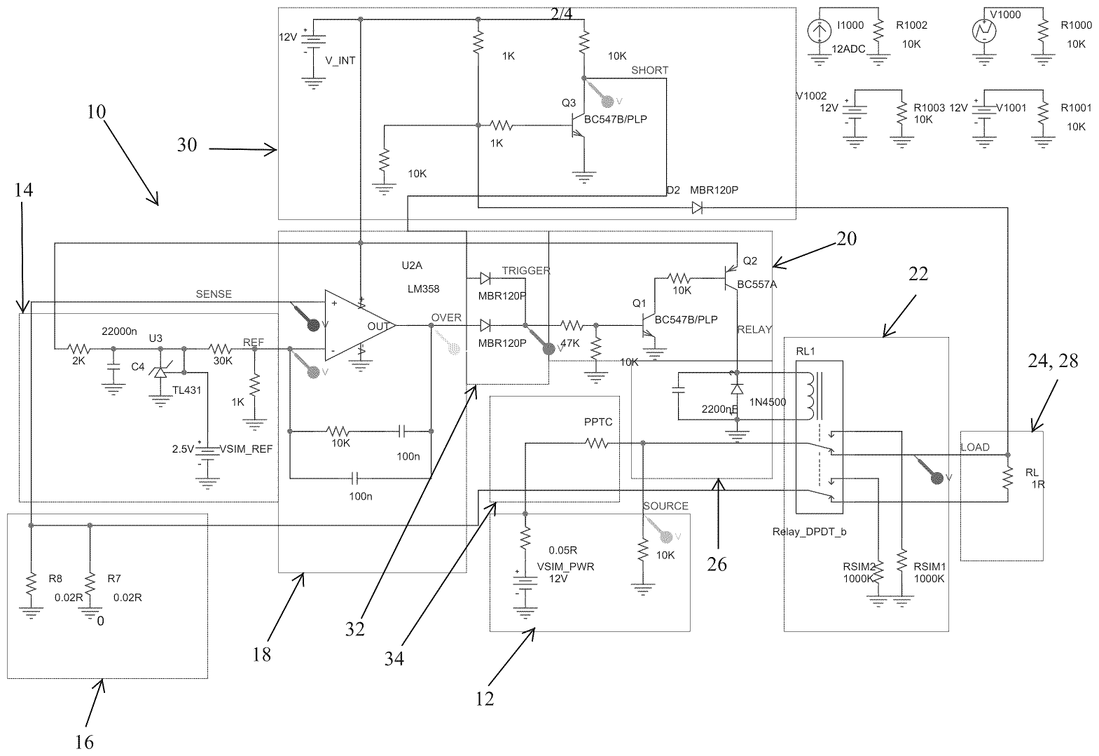

Referring now to the figures, FIGS. 1 and 2 show an inherently limited self-protection circuit 10 according to multiple embodiments. The self-protection circuit 10 works to protect against an overcurrent short resulting from a short circuit. The self-protection circuit 10 can include a power supply 12, fixed reference (REF) control circuit 14, fail safe fuse 34, current sensing circuit 16, comparison circuit 18, latching circuit 20, electric relay 22, low wattage output circuit 24, relay protective circuit 26, load 28, post relay short circuit detection or feedback circuit 30, and logic combinator 32.

The current sensing circuit 16 determines an input voltage provided by the power supply 12. The control circuit 14 sets a threshold voltage. The comparison circuit 18 compares the input voltage to the threshold voltage. The latch circuit 20 controls the electric relay 22 which opens and closes the low-wattage output circuit 24 to provide an output voltage based on the comparison of the input voltage and the threshold voltage. The low wattage output circuit 24 is open when the input voltage is less than the threshold voltage and closed when the input voltage is greater than the threshold voltage. The relay protective circuit 26 protects the electric relay 22 by consuming extra voltage produced when the electric relay 22 closes the low wattage output circuit 24.

The post relay short circuit detection circuit 30 inhibits relay reconnection under persistent fault conditions. The circuit 30 ensures that fault continuity is verified even after the relay disengages. This feedback loop circuit 30 is implemented using a voltage drop detection subcircuit with a breakdown diode (e.g., K110) and resistive divider, which sense the voltage across the load. When a persistent low-voltage condition is present (which indicates an unresolved short), the signal is routed through a high-voltage NPN transistor (e.g., MMBTA42) that outputs a digital interrupt (e.g., INT3). This interrupt can be routed to a controller to initiate a fail-safe, lock the relay or trigger alerts.

The fail-safe fuse 34 serves as a redundant protection path. The fail-safe fuse 34 can be, for example, a passive electronic component used to protect against an overcurrent fault, such as a polymeric positive temperature coefficient (PPTC) device, a multifuse/polyfuse/polyswitch, or a permanent fuse. The fail-safe fuse 34 is positioned between the power input 12 and the electric relay 22 as a permanent protective layer. The fail-safe fuse 34 serves as a preemptive barrier against high inrush or fault current and self-resets after the condition clears. This fuse 34 adds redundancy to the circuit 10 and ensures that even in cases of latch failure or prolonged overcurrent, a passive, self-regulating element limits damage to the circuit 10.

In a present embodiment, the fixed reference (REF) control circuit 14 caps the output at 60VA at 12VDC. The logic combinator circuit 32 receives the overcurrent trigger signal and the short circuit signal and inhibits relay closure if either signal is present. In an embodiment, the logic combinator circuit 32 can be a discrete transistor based logic network that performs an OR operation between the outputs of the short circuit detection circuit 30 and the overcurrent comparison circuit 18.

The self-protection circuit 10 provides a voltage output to load 28 when the input voltage is less than the threshold voltage and the low wattage output circuit 24 is open.

In an embodiment, the threshold voltage is set using a fixed resistor and the self-protection circuit has a +/−5% tolerance and can quickly reset. The current sensing circuit 16, for example, may be set to 60VA (60VA/12V=5 A) max power output, such that the power supply is inherently limiting. Table 1, below, shows the maximum current and power table for Class 2 power supplies, as provided in UL 1310 (2022).

TABLE 1
Maximum Current and Power for Class 2 Power Supplies

| Circuit voltage | Maximum nameplate | | |
|---|---|---|---|
| (Vₘₐₓ)^{a, b} | ratings | | Maximum output current |
| ac or dc Volts | Volt-Amperes | Amperes | (Iₘₐₓ)^{c}, Amperes |
| 0-20 | 5.0 × Vₘₐₓ | 5.0 | 8.0 |
| Over 20 to 30 | 100 | 100/Vₘₐₓ | 8.0 |
| Over 30 to 60, | 100 | 100/Vₘₐₓ | 150/100/Vₘₐₓ |
| dc only | | | |

^{a}Vₘₐₓ: Maximum output voltage regardless of load with rated input voltage.
^{b}Voltage ranges shown are for sinusoidal alternating current and continuous direct current. For non-sinusoidal alternating current, maximum voltage shall not be grater than 42.4 volts peak. For direct current interrupted at a rate of 10-200 hertz, maximum voltage shall not be greater than 24.8 volts.
^{c}Iₘₐₓ is the maximum output current regardless of load.

FIG. 2 shows a self-protection circuit 10 according to an embodiment. The self-protection circuit 10 includes a current sensing circuit 16 that determines the input voltage U, a control circuit 14 that sets a threshold voltage U1, a comparison circuit 18 that compares the input voltage U to the threshold voltage U1, a latching circuit 20 that controls an electric relay 22 which opens and closes a low wattage output circuit 24 based on the comparison circuit 18, and the relay protective circuit 26 for the electric relay 22 that consumes extra voltage produced when the electric relay 22 is closed. The self-protection circuit 10, through the voltage output circuit 24, provides a voltage output when the input voltage U is less than the threshold voltage U1.

The self-protection circuit 10, through the relay protective circuit 26 for the electric relay 22, consumes the extra voltage and does not output a voltage at the voltage output circuit 24 when the input voltage U is greater than the threshold voltage U1. The threshold voltage U1 is set using an adjustable resistor VR1 and the self-protection circuit has a +/−5% tolerance that can quickly reset.

In an embodiment, the current sensing circuit 16 has a direct current (DC) voltage input from a power supply 12; the power supply 12 may be part of a power kit. The output of the current sensing circuit 16 may drive external devices like light-emitting diodes (LEDs).

The current sensing circuit 16 includes resistors R7 and R8 that have a voltage based on the current that comes through the resistors. The voltage U can be calculated based on Ohm's law (U=I*R), where a higher current will result in a higher voltage difference while R7 and R8 are fixed. The voltage U can be used as a comparison voltage for the comparison circuit 103.

The control circuit 14 includes a voltage regulator TL431, resistors R10 and R11. The control circuit 14 sets the threshold voltage U1.

In an embodiment, if the current I is equal to 9.7 A and R7 and R8 have a resistance of 0.01Ω, the voltage U will be 9.7 A (I)*0.1Ω(R)=0.097V. The comparison circuit 18 will compare the voltage U from the current sensing circuit 16 with the threshold voltage U1 set by the control circuit 14.

In an embodiment, the threshold voltage U1=(R10/Rtotal)*U3, where Rtotal=total value added with R11=15 kΩ, VR1=10 kΩ, and R10=1 kΩ, U3 is the settled voltage of the voltage regulator TL431, for example, 2.5V. Thus, the threshold voltage U1 can be set to 0.096V as U1=(1/(15+10+1))*2.5V=0.096V.

The comparison circuit 18 includes an op-amp comparator OA (LM358), resistor R12, and capacitors C5 and C6. The op-amp comparator OA's input lead 3 has the input voltage U from the current sensing circuit 16 and the input lead 2 has the threshold voltage U1 from the control circuit 14. The op-amp comparator OA will compare the difference between the input voltage U and the threshold voltage U1. In an embodiment, when U>U1, the output lead 1 of the op-amp comparator OA is in high mode and when U<U1, the op-amp comparator OA is in low mode.

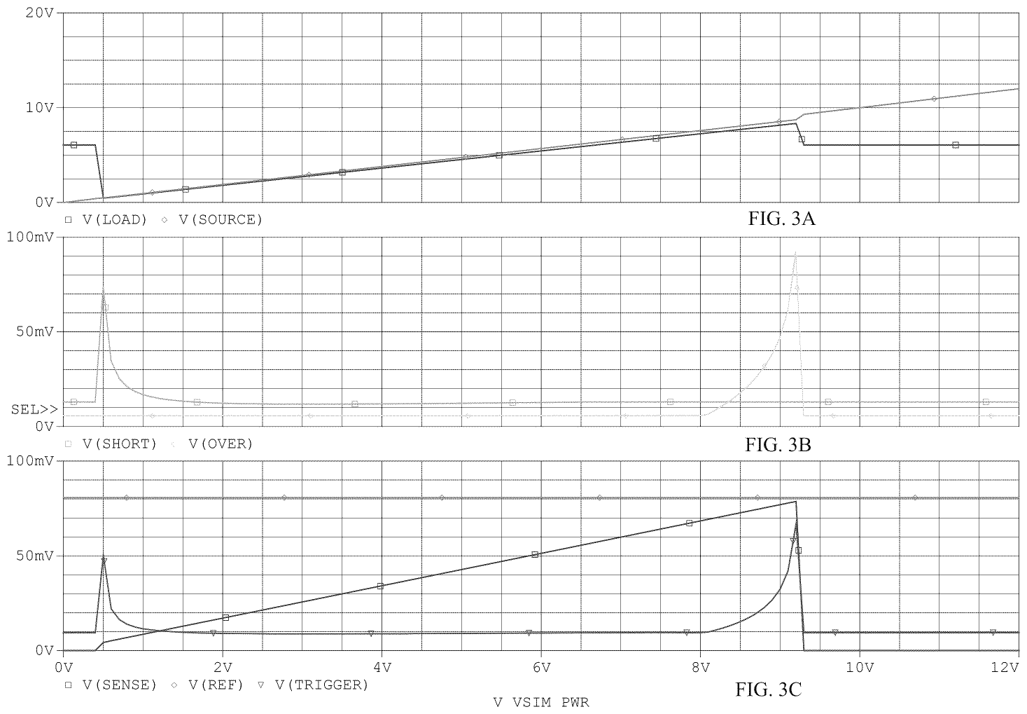

Latching circuit 20 includes NPN styled transistor Q1 and PNP styled transistor Q2. Each transistor has 3 leads (base, collector, emitter, as shown in FIG. 3). The base lead of the transistor Q1 is connected to the output of comparison circuit 103. The emitter lead of the transistor Q1 is grounded. The collector lead of the transistor Q1 is connected to the base lead of the transistor Q2. The emitter lead of the transistor Q2 is connected to the power supply. The base lead of the transistor Q1 converges with the collector lead of the transistor Q2 at one conjunction and then outputs to the electric relay 105.

In an embodiment, the electric relay 22 includes electric relay RL1.

In an embodiment, when the comparison circuit 18 is at high mode (U>U1), the base lead of the transistor Q1 is also at high mode and thus resulting in the break-over (conducting) of the transistor Q1. Also, the base lead of the transistor Q2 is at high mode and the transistor Q2 is at break-over (conducting). This results in the high mode of the latch circuit 104 output and the electric relay RY1 being activated.

In an embodiment, the electric relay RL1 is normally not activated and closed and when activated, it moves to an open state. When the electric relay RL1 is closed it is conducting and when it becomes open it is disconnected. In operation, the electric relay RL1 is closed when U<U1 and the electric relay RL1 is activated (becomes open) when U>U1 and cuts off the output preventing electricity from going to a load via wattage output circuit 24.

In another embodiment, the electric relay RL1 is normally activated and closed, and when not activated, it moves to an open state. In operation, the electric relay RL1 is closed when U<U1 and the electric relay RL1 is activated (becomes open) when U>U1 and cuts off the output preventing electricity from going to a load via low wattage output circuit 24.

The low wattage output circuit 24 is a low wattage circuit which consist of output terminals (v+v—which are open/disconnected) between load and power supply. The electric relay RL1 is used to control the open or close state of the terminals in the low wattage output circuit 24. When the electric relay RL1 is activated/disconnected, there is no output to the load and when the electric relay RL1 is deactivated, electricity moves to the load via the normally closed the electric relay RL1.

In an embodiment, the electric relay RL1 includes a mechanical relay.

The relay protective circuit 26 includes a protective capacitor C13 and a diode D1, which are connected in parallel. The protective circuit 26 protects electric relay 22, which is connected in parallel, by consuming the extra energy/voltage produced at the moment when electric relay RL1 is activated, as there will be a large increase in voltage at both ends of the relay when the relay opens/disconnects suddenly. The relay protective circuit 26 further protects the system from the voltage increase feeding back to the NPN styled transistor Q1 of the comparison circuit 18, resulting in a comparison misread (U<U1) and causing the low wattage output circuit 24 to shift between open and close as feedback occurs.

FIGS. 3A-3C are graphical illustrations of simulated time domain analyses. FIG. 3A shows the current increase behavior of the protection circuit in volts (y-axis) vs. time (x-axis) in the presence of increasing current, FIG. 3B shows the behavior of the short circuit protection circuit in volts (y-axis) vs. time (x-axis) the presence of increasing current, and FIG. 3C shows the behavior of the control circuit in volts (y-axis) vs. time (x-axis) the presence of increasing current.

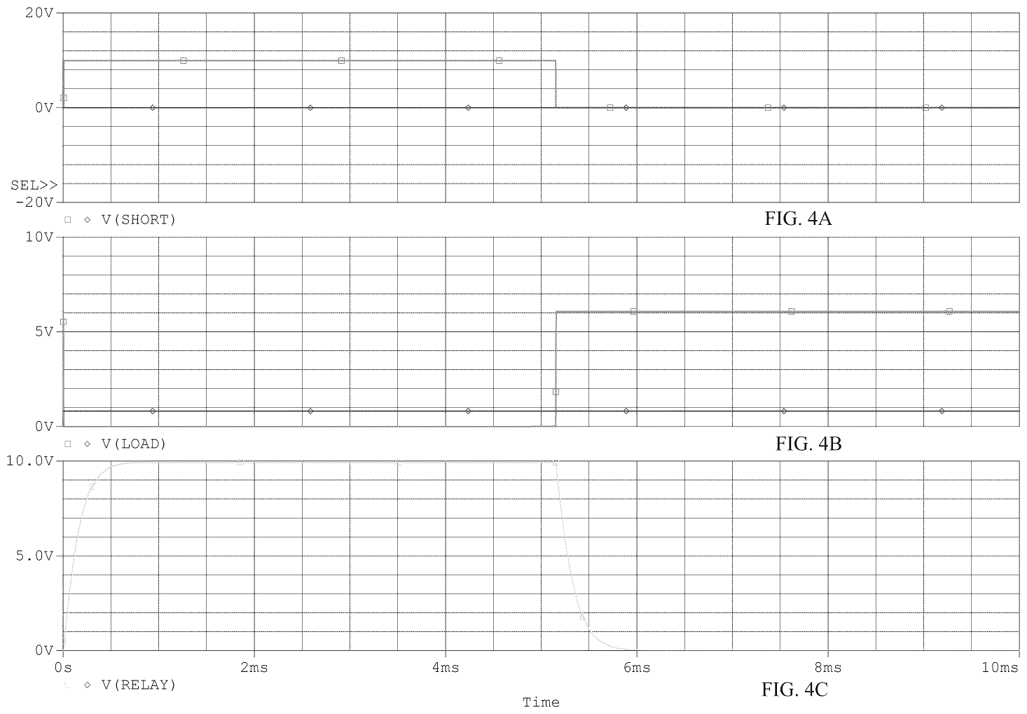

FIGS. 4A-4C are graphical illustrations of simulated parametric domain analyses. FIG. 4A shows the behavior of the protection circuit in volts (y-axis) vs. time (x-axis) in the presence of two inputs at the same time (normal and edge current), FIG. 4B shows the behavior of the load (low power output) in volts (y-axis) vs. time (x-axis) in the presence of two inputs at the same time (normal and edge current), and FIG. 4C shows the behavior of the electric relay in volts (y-axis) vs. time (x-axis) in the presence of two inputs at the same time (normal and edge current).

Thus, the self-protection circuit 10 may be set to, for example, a maximum power output of 60VA (60VA/12V=5 A) to meet UL 1310 requirements. UL1310 or Class 2 certification requires that in a self-protecting Class 2 power supply, the value of the tripping current must be fixed in the circuit. As such, in a present embodiment, the maximum current set by the reference is fixed. The value can be adjusted during production based on the voltage. For example, for 12V power supply, the self-protection circuit 10 can be set to achieve 5 A (60VA/12V=5 A), and for example for a 48V power supply, the self-protection circuit 10 can be set to achieve 2.08 A (100VA/48V=2.08 A) to satisfy the Class 2 requirements. The self-protection circuit breaker 10 can accomplish a +/−5% tolerance and does not depend on temperature levels for resetting.

From the foregoing it will be observed that numerous modifications and variations can be effectuated without departing from the true spirit and scope of the novel concepts of the present disclosure. It is to be understood that no limitation with respect to the specific embodiments illustrated is intended or should be inferred. The disclosure is intended to cover by the appended claims all such modifications as fall within the scope of the claims.

What is claimed is:

1. A protection circuit configured for inline installation between a DC power source and a load, the protection circuit comprising:
a current sensing circuit configured to measure current flowing toward the load;
a control circuit having a non-adjustable reference voltage element, the control circuit configured to define a fixed overcurrent threshold corresponding to a power limit of about 60 volt-amperes;
a comparison circuit operably coupled to the current sensing circuit and the control circuit, the comparison circuit configured to generate an overcurrent trigger signal;
a latching circuit configured to actuate an electric relay based on the overcurrent trigger signal;
a logic combinator circuit configured to receive the overcurrent trigger signal and a short-circuit signal, and inhibit closure of the electric relay if either the overcurrent trigger signal or the short-circuit signal is asserted;
a short-circuit detection circuit located electrically between the electric relay and the load, the short-circuit detection circuit configured to detect persistent short circuits downstream of the electric relay, the electric relay configured to disconnect the load from the DC power source when actuated; and
a low wattage output circuit downstream of the electric relay, the low wattage output circuit comprising a fail-safe protection device configured to permanently or temporarily open under sustained fault conditions.

2. The protection circuit of claim 1, wherein the current sensing circuit includes a pair of resistors.

3. The protection circuit of claim 1, wherein the control circuit includes a TL431 programmable reference regulator configured as a fixed reference voltage source to ensure a constant overcurrent threshold.

4. The protection circuit of claim 1, wherein the comparison circuit includes an operational amplifier, a resistor and a pair of capacitors.

5. The protection circuit of claim 1, wherein the latching circuit includes an NPN transistor, a PNP transistor, and resistors.

6. The protection circuit of claim 1, wherein the logic combinator circuit includes a discrete transistor-based logic network to perform an OR operation between outputs of the short-circuit detection circuit and the comparison circuit.

7. The protection circuit of claim 1, wherein the short-circuit detection circuit is electrically coupled to the electric relay and the load, the short-circuit detection circuit configured to sense fault conditions at a load terminal only when the electric relay is in the closed state.

8. The protection circuit of claim 1, wherein the short-circuit detection circuit includes an NPN transistor, and resistors.

9. The protection circuit of claim 1, wherein the fail-safe protection device is one of a polymeric positive temperature coefficient (PPTC) and a permanent one-time fuse with a calibrated trip behavior resettable fuse.

10. The protection circuit of claim 1, wherein the low wattage output circuit includes a resistor and is load limited to 60VA.

11. The protection circuit of claim 1, wherein the logic combinator maintains the electric relay in an open state upon detection of a persistent short circuit and inhibits automatic reclosure until the fault condition is removed.

12. The protection circuit of claim 1, wherein the fixed overcurrent threshold of the control circuit is selected such that at a DC voltage of 12V, the output current is dynamically limited to maintain a power delivery ceiling not exceeding 60 VA.

13. The protection circuit of claim 1, wherein the latching circuit is configured to retain a state upon activation of either the overcurrent trigger signal or the short-circuit signal, and requires manual or power-reset intervention to restore a connection of the protection circuit.

14. A fail-safe DC load protection architecture comprising:
a first-stage overcurrent control block comprising a current sensor, a comparator, and a control reference;
a latching relay circuit triggered upon exceeding a fixed current threshold;
a short-circuit detection block positioned after the relay and configured to prevent relay reclosure upon detection of a load-side short; and
a secondary protection device integrated into the output circuit to permanently or thermally disconnect in the event of an upstream failure.

15. The fail-safe DC load protection architecture of claim 14, wherein the architecture is configured to limit a maximum power output to less than or equal to 60 VA under all loading conditions, including a transient startup condition and a sustained short-circuit condition.

16. The fail-safe DC load protection architecture of claim 14, wherein the secondary protection device is a polymeric positive temperature coefficient (PPTC), or a permanent one-time fuse with a calibrated trip behavior resettable fuse.
